(19) United States
(12) Patent Application Publication
(10) Pub. No.: US 2024/0411558 A1
(43) Pub. Date: Dec. 12, 2024

(54) PROGRAM CONVERSION DEVICE, PROGRAM CONVERSION METHOD, AND RECORDING MEDIUM

(71) Applicant: NEC Corporation, Minato-ku, Tokyo (JP)

(72) Inventor: Kazuhisa Ishizaka, Tokyo (JP)

(73) Assignee: NEC Corporation, Minato-ku, Tokyo (JP)

(21) Appl. No.: 18/704,517

(22) PCT Filed: Dec. 3, 2021
(86) PCT No.: PCT/JP2021/044518

§ 371 Date: Apr. 25, 2024

(51) Int. Cl. G06F 9/30

(52) U.S. Cl. CPC G06F 9/30058

(57) ABSTRACT

A program conversion device analyzes a first program and detects a portion of the first program that includes a conditional branch and calculates a value according to an execution result of the conditional branch; and generates, on the basis of the analysis result, a second program including a plurality of combinations of a conditional expression and a calculation expression and using a value indicated by the calculation expression combined with the conditional expression that becomes true, wherein the calculation expression indicates the value and does not include a conditional branch and only one conditional expression from among the plurality of conditional expressions becomes true.

### TECHNICAL FIELD

This invention relates to a program conversion device, a program conversion method, and a recording medium.

### BACKGROUND ART

There are cases where program conversions, such as source-level program conversion, are performed.

For example, the language conversion device described in Patent Document 1 searches for locations in the source program that are described by the same character string as the reserved word, and determines whether the searched character string is used as a reserved word or as the character string of variables. If it is determined that the searched string is not used as a reserved word and is used as the character string of variables, this language converter converts the searched string into another string.

### PRIOR ART DOCUMENTS

### Patent Document

Patent Document 1: PCT International Publication No. WO 2009-251684

### SUMMARY OF THE INVENTIONS

### Problems to be Solved by the Invention

It is desirable to be able to convert programs so that they can be executed more efficiently.

An example of an object of the present invention is to provide a program conversion device, a program conversion method, and a recording medium that can solve the above-mentioned problems.

### Means for Solving the Problem

According to the first example aspect of the present invention, a program conversion device is provided with an analysis means that analyzes a program and detects a portion that includes a conditional branch and calculates a value according to an execution result of the conditional branch; and a program generation means that generates, on the basis of the analysis result, a program which is provided with a plurality of combinations of a conditional expression and a calculation portion indicating a value and configured without including a conditional branch, and which uses a value indicated by the calculation portion combined with the conditional expression that becomes true, where only one conditional expression from among the plurality of conditional expressions becomes true.

According to the second example aspect of the present invention, a program conversion method includes a computer analyzing a program and detecting a portion that includes a conditional branch and calculates a value according to an execution result of the conditional branch; and generating, on the basis of the analysis result, a program which is provided with a plurality of combinations of a conditional expression and a calculation portion indicating a value and configured without including a conditional branch, and which uses a value indicated by the calculation portion combined with the conditional expression that becomes true, where only one conditional expression from among the plurality of conditional expressions becomes true.

According to the third example aspect of the present invention, a recording medium is one that records a program for causing a computer to analyze a program and detect a portion that includes a conditional branch and calculates a value according to an execution result of the conditional branch; and generates, on the basis of the analysis result, a program which is provided with a plurality of combinations of a conditional expression and a calculation portion indicating a value and configured without including a conditional branch, and which uses a value indicated by the calculation portion combined with the conditional expression that becomes true, where only one conditional expression from among the plurality of conditional expressions becomes true.

### Effect of Invention

According to the present invention, programs can be converted so that program execution can be made more efficient.

### BRIEF DESCRIPTION OF THE DRAWINGS

FIG. 1 is a diagram showing an example of the configuration of the program conversion device according to the example embodiment.

FIG. 2 is a diagram showing an example of data input to the pre-conversion program or the post-conversion program according to the example embodiment.

FIG. 3 is a diagram showing an example of data output by the pre-conversion program or the post-conversion program.

FIG. 4 is a diagram showing an example of a pre-conversion program according to the example embodiment.

FIG. 5 is a diagram showing an example of an abstract syntax tree according to the example embodiment.

FIG. 6 is a diagram showing an example of the pair of a return value indicated by an abstract syntax tree and a conditional expression indicating the condition under which the return value is adopted.

FIG. 7 is a diagram showing an example of conversion from a conditional expression to a conditional expression naming statement by the program generation portion of the example embodiment.

FIG. 8 is a diagram showing an example of a conditional assignment statement generated by the program generation portion according to the example embodiment.

FIG. 9 is a diagram showing an example of a post-conversion program generated by the program generation portion of the example embodiment.

FIG. 10 is a flowchart showing an example of a processing procedure in which the analysis portion according to the example embodiment generates a set of pairs of return values and conditional expressions.

FIG. 11 is a flowchart showing an example of the procedure in which the program generation portion according to the example embodiment generates a post-conversion program.

FIG. 12 is a diagram showing an example of the configuration of the program conversion device according to the example embodiment.

FIG. 13 is a diagram showing an example of the processing procedure in the program conversion method according to the example embodiment.

FIG. 14 is a schematic block diagram showing the configuration of a computer according to at least one example embodiment.

### EXAMPLE EMBODIMENT

The following is a description of example embodiments of the present invention, but the following example embodiments do not limit the claimed invention. Not all of the combinations of features described in the example embodiments are essential to the solution of the invention.

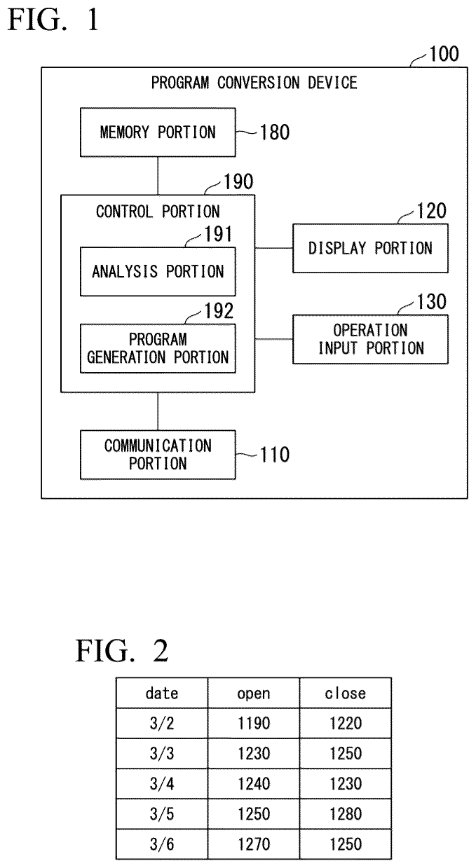

FIG. 1 is a diagram showing an example of the configuration of the program conversion device according to the example embodiment. In the configuration shown in FIG. 1, a program conversion device 100 is provided with a communication portion 110, a display portion 120, an operation input portion 130, a memory portion 180, and a control portion 190. The control portion 190 is equipped with an analysis portion 191 and a program generation portion 192.

The program conversion device 100 converts programs. In particular, the program conversion device 100 converts a program which includes a conditional branch and calculates a value according to an execution result of the conditional branch into a program which is provided with a plurality of combinations of a conditional expression and a calculation portion presenting a value and configured without including a conditional branch, and which uses a value indicated by the calculation portion combined with the conditional expression that becomes true, where only one conditional expression from among the plurality of conditional expressions becomes true.

The calculation portion is configured as a calculation equation that does not include a conditional branch. The calculation equation here may be a constant. That is, the calculation equation may be an equation consisting only of constant terms. Therefore, the value indicated by the calculation portion may be a value of a calculation equation (calculated value) or a constant value. The constant value can be interpreted as a kind of calculation equation value.

The pre-conversion program and the post-conversion program output the same data for the same data input.

The post-conversion program has a structure suitable for faster computation, for example, parallel processing, in that the computation portion does not include conditional branches. According to the program conversion device 100, calculations can be performed at relatively high speeds.

The conversion of a program here may be to rewrite the program to be converted or to generate a post-conversion program separately from the program to be converted.

Both rewriting the program to be converted and generating the post-conversion program separately from the program to be converted can be said to generate the post-conversion program. Rewriting the program to be converted can be said to be generating the post-conversion program using the program to be converted.

A program prior to conversion by the program conversion device 100 (the program to be converted) is also referred to as the pre-conversion program. A program after conversion by the program conversion device 100 is also referred to as the post-conversion program.

The communication portion 110 communicates with other devices. For example, if the storage device storing the pre-conversion program is included in a device other than the program conversion device 100, the communication portion 110 may receive the pre-conversion program from that device. If the execution environment for the post-conversion program is provided in a device other than the program conversion device 100, the communication portion 110 may transmit the post-conversion program to that device.

The display portion 120 is provided with a display screen, such as a liquid crystal panel or LED (Light Emitting Diode) panel, for example, and displays various images. For example, the display portion 120 may display one or more of the pre-conversion program, the data at the time of program conversion, and the post-conversion program.

The operation input portion 130 is provided with input devices such as a keyboard and mouse, for example, and accepts user operations. For example, the operation input portion 130 may accept user operations that indicate the conversion of the program and the acquisition source of the pre-conversion program.

The memory portion 180 stores various data. For example, the memory portion 180 stores the algorithm for the process of analyzing the pre-conversion program and the algorithm for the process of converting the program. The memory portion 180 may store these algorithms in a program.

In addition, the memory portion 180 stores the pre-conversion program. When the program conversion device 100 acquires the pre-conversion program from another device, the memory portion 180 may temporarily store the acquired pre-conversion program.

In addition, the memory portion 180 stores the post-conversion program. When the program conversion device 100 outputs the post-conversion program to other devices, the memory portion 180 may temporarily store the post-conversion program.

The control portion 190 controls the various parts of the program conversion device 100 to perform various processes. The functions of the control portion 190 are performed, for example, by the CPU (Central Processing Unit) provided by the program conversion device 100, which reads the program from the memory portion 180 and executes it.

The analysis portion 191 analyzes the pre-conversion program. In particular, the analysis portion 191 detects in the analysis a portion of the pre-conversion program that includes a conditional branch and calculates a value according to an execution result of the conditional branch. The analysis portion 191 is an example of an analysis means.

The portion detected by the analysis portion 191 that includes a conditional branch and calculates a value according to an execution result of the conditional branch can be the part to be converted in the conversion of the program.

The analysis portion 191 may use an abstract syntax tree to analyze the program. For example, if the program conversion device 100 uses the abstract syntax tree in processes other than program conversion, such as a compiler or interpreter, the abstract syntax tree or the abstract syntax tree generation algorithm may also be used for program conversion by the program conversion device 100. This eliminates the need to separately generate abstract trees or separately prepare algorithms for program conversion by the program conversion device 100.

The program generation portion 192 converts the program based on the results of analysis by the analysis portion 191. In particular, the program generation portion 192 replaces assignment statements based on conditional branching with conditional assignment statements. A conditional assignment statement consists of a combination of a conditional expression and a calculation portion that is composed without a conditional branch and indicates a value.

If the pre-conversion program contains an assignment statement with an if-then-else conditional branch, or an assignment statement with a nested structure of if-then-else conditional branches, the program generation portion 192 replaces this assignment statement with multiple conditional assignment statements. if-then-else conditional branches may be explicitly indicated using an if-then-else statement, or they may be implicitly indicated by, for example, using a return command in a function.

The program generation portion 192 sets the conditional expressions of multiple conditional assignment statements so that only one of the conditional expressions becomes true exclusively. In the post-conversion program, the value indicated by the calculation portion combined with the conditional expression that has become true is used as the value to be assigned by the assignment statement.

FIG. 2 is a diagram showing an example of data input to the pre-conversion program or the post-conversion program. As mentioned above, the pre-conversion program and the post-conversion program output the same data with respect to the same data input.

FIG. 2 shows the data in tabular (table) format, with a “date” column, an “open” column, and a “close” column. Thus, each row of data in FIG. 2 includes a column for the item “date”, a column for the item “open”, and a column for the item “close”.

Tabular data can be understood as data in matrix form. The rows of the table correspond to the rows of the matrix, and the columns of the table correspond to the columns of the matrix. Each cell in the rows and columns of the table corresponds to an element of the matrix.

FIG. 2 shows time-series data on market prices, such as the price of a company's stock.

In the example in FIG. 2, the “date” column of each row contains the date when the data in that row was observed. The “open” column of each row contains the opening price of the day indicated in the “date” column. The “close” column of each row contains the closing price for the day indicated in the “date” column.

However, the data handled by the program converted by the program conversion device 100 is not limited to specific content data. The data handled by the program converted by the program conversion device 100 is not limited to data in a specific format.

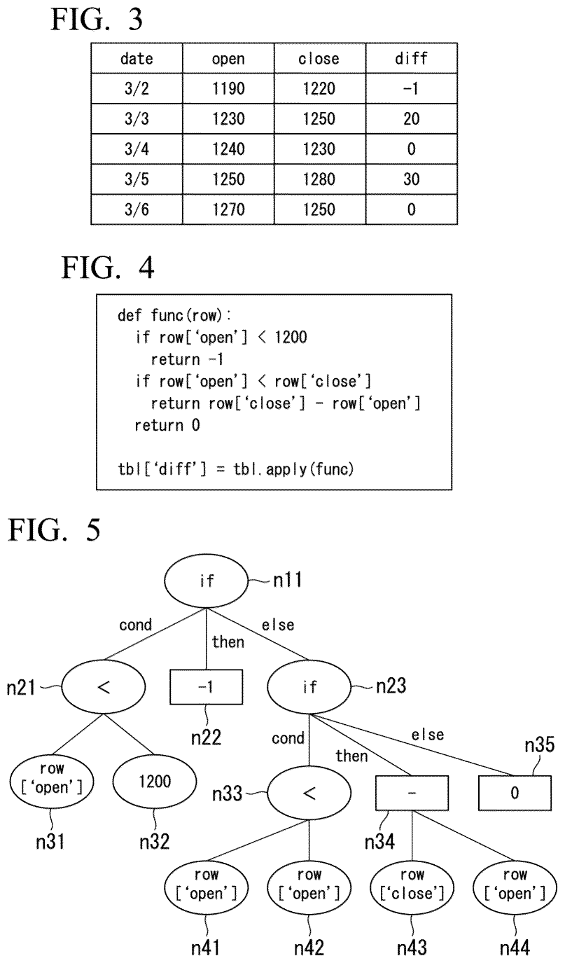

FIG. 3 shows examples of data output by the pre-conversion or post-conversion programs.

FIG. 3 shows an example of the data output by a pre-conversion or post-conversion program that receives the data input shown in FIG. 2. As described above, the pre-conversion program and the post-conversion program output the same data with respect to the same data input. Here, it is assumed that both the pre-conversion program and the post-conversion program output the data shown in FIG. 3 in response to the data input shown in FIG. 2.

In the data shown in FIG. 3, the “diff” column has been added to the data shown in FIG. 2. The “diff” column of each row contains a value based on a comparison of the value in the “open” column with the value in the “close” column in that row.

Specifically, if the value in the “open” column is less than 1200, the value in the “diff” column is “−1”.

On the other hand, if the value in the “open” column is equal to or greater than 1200, when the value in the “close” column is greater than or equal to the value in the “open” column, the value of the difference obtained by subtracting the value in the “open” column from the value in the “close” column is stored in the “diff” column. If the value in the “open” column is equal to or greater than 1200 and the value in the “close” column is less than the value in the “open” column, the value in the “diff” column is “0”.

However, the processing that the pre-conversion program or post-conversion program performs on matrix-format data (tabular data) is not limited to adding columns. Furthermore, the data handled by the pre-conversion program or post-conversion program is not limited to data in matrix form.

If the pre-conversion program or post-conversion program handles data in matrix form, it may add columns, delete columns, or update the value of each element in a column, or perform other processing on the columns. Alternatively, the pre-conversion program or post-conversion program may perform processing on rows, such as adding rows, deleting rows, or updating the value of each element in the row.

The pre-conversion program or post-conversion program may perform both row and column processing, or only one of row or column processing.

Any one of the rows and columns of the matrix is also denoted as first data series. The rows and columns of the matrix that differ from the first data series are also denoted as the second data series.

In the case of processing for columns, such as the addition of columns illustrated in FIGS. 2 and 3, rows correspond to examples of the first data series and columns correspond to examples of the second data series. On the other hand, in the case of processing for rows, columns correspond to examples of the first data series and rows correspond to examples of the second data series.

FIG. 4 is a diagram showing an example of a pre-conversion program.

In the program shown in FIG. 4, “def func(row):” through “return 0” indicates the definition of the user-defined function “func”.

“tbl[‘diff’]=tbl.apply(func)” indicates that the user-defined function “func” is called for every row of tabular data “tbl” to create a column consisting of the return value of each row and assign it to the “diff” column of tabular data “tbl”.

In the function call “tbl.apply(func)”, one line of data from the tabular data “tbl” is passed to the user-defined function “func” as an argument. Rows of tabular data “tbl” that are passed to the user-defined function “func” as arguments are also called rows to be processed.

In the definition of the user-defined function “func”, the row to be processed is denoted as “row”.

The computer executing the user-defined function “func” compares the value of the “open” column of the row “row” to be processed with 1200 in “if row[‘open’]<1200 return−1”. If the value in the “open” column is less than 1200, the computer sets the return value to “−1” and terminates the execution of the user-defined function “func” for one line of data in the data “tbl”.

On the other hand, if the value in the “open” column is 1200 or more, the process proceeds to “if row[‘open’]<row[‘close’] . . . ”.

Thus, “if . . . return . . . ” implicitly indicates an if-then-else conditional branch. Here, “if row[‘open’]<1200 return−1 . . . ” is an example of the implication of an if-then-else conditional branch.

A computer executing the user-defined function “func” compares the value in the “open” column of the row to be processed with the value in the “close” column in “if row[‘open’]<row[‘close’] return row[‘close’]−row[‘open’]”. If the value in the “open” column is less than the value in the “close” column, the computer terminates execution of the user-defined function “func” for one line of data in the data “tbl” with the difference obtained by subtracting the value in the “open” column from the value in the “close” column as the return value.

On the other hand, if the value in the “open” column is greater than or equal to the value in the “close” column, the process proceeds to “return 0”. “if row[‘open’]<1200 return−1 . . . ” is another example of an if-then-else conditional implication.

At “return 0”, the computer executing the user-defined function “func” sets the return value to “0” and terminates the execution of the processing of the user-defined function “func” for one line of data in data “tbl”.

The following describes an example of the case in which the pre-conversion program makes a call to a user-defined function, as in the example in FIG. 4. However, programs to be converted by the program conversion device 100 are not limited to those that make calls to user-defined functions.

For example, the pre-conversion program may be configured to call a subroutine defined by the user and assign the return value to a global variable within the subroutine. In this case, the return value of the user-defined function can be read as the return value assigned to the global variable in the following explanation.

User-defined functions and user-defined subroutines are collectively referred to as user-defined modules.

Alternatively, the pre-conversion program may be configured without a user-defined module. Specifically, a formula for calculating the desired value, such as calculating the value of each element of a new column, may be embedded in the body of the program in the pre-conversion program. In this case, the return value of the user-defined function can be read as the desired value in the following explanation.

FIG. 5 shows an example of an abstract syntax tree. FIG. 5 shows the abstract syntax tree for the pre-conversion program shown in FIG. 4.

In the example in FIG. 5, the codes shown for each node are for illustrative purposes. There is no need for the actual abstract syntax tree to be marked with such codes.

As shown above, in the pre-conversion program, “if . . . return . . . ” implicitly indicates an if-then-else conditional branch, which is structured as an if-cond-then-else tree structure in the abstract syntax tree shown in FIG. 5.

The square nodes in the abstract syntax tree in FIG. 5 (nodes n22, n34, and n35) indicate that they are return value notations. For example, node n34, which is the square surrounding “−”, indicates that the return value is the difference obtained by subtracting the value in the “open” column from the value in the “close” column in the row to be processed. Thus, the return value may be expressed as an expression.

In the program conversion device 100, the analysis portion 191 generates the abstract syntax tree illustrated in FIG. 5. The program conversion device 100 may use an existing method as the method of generating an abstract syntax tree.

Alternatively, as described above, if the program conversion device 100 also uses the abstract syntax tree in processes other than program conversion, such as a compiler or interpreter, the abstract syntax tree or the abstract syntax tree generation algorithm may also be used for program conversion by the program conversion device 100.

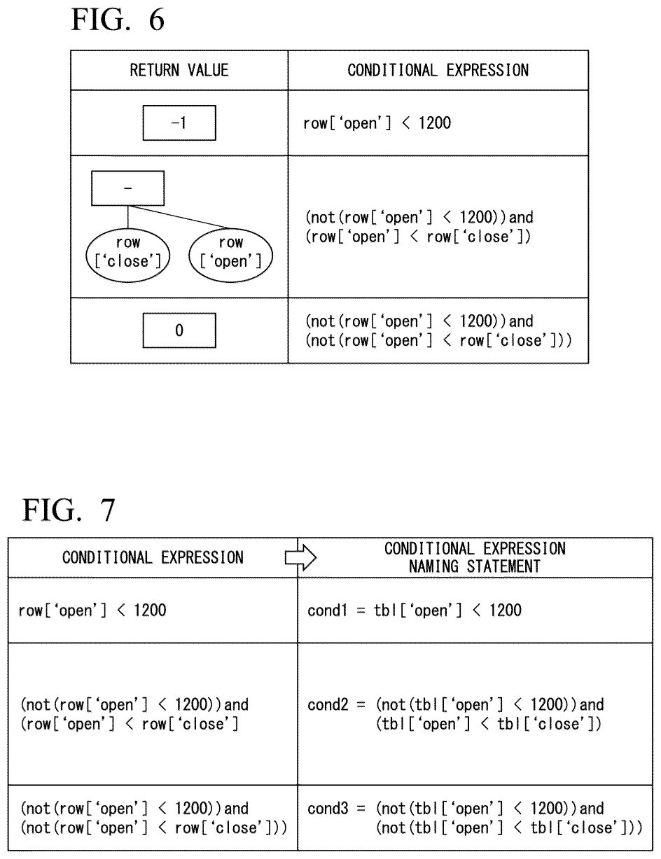

FIG. 6 is a diagram showing an example of a pair consisting of return values shown in an abstract syntax tree and conditional expressions indicating the condition under which the return value is adopted.

The analysis portion 191 can use the abstract syntax tree to generate the pair consisting of the return value and the conditional expression illustrated in FIG. 6.

For example, if the analysis portion 191 traces the tree from node n34, where “−” is surrounded by a square in the abstract syntax tree in FIG. 5, to the parent side, node n34 is set to then in the tree structure of the if statement indicated by node n23. Therefore, the analysis portion 191 refers to node n33 of cond and the descendant nodes thereof in the tree structure of this if statement to obtain the conditional expression “row[‘open’]<row[‘close’]”.

When the analysis portion 191 further traces the tree to the parent side, node n23 of the above if statement is set to else in the tree structure of a higher-level if statement (the if statement indicated by node n11). Therefore, the analysis portion 191 refers to node n21 of cond and the descendant nodes thereof in the tree structure of this if statement to obtain the conditional expression “row[‘open’]<1200”.

Node n34, where the analysis portion 191 starts its search, is included in the else of the if statement indicated by node n11. Therefore, the analysis portion 191 adds “not” to the conditional expression “row[‘open’]<1200” to make it “not(row[‘open’]<1200)”.

Then, the analysis portion 191 combines the conditional expressions “not(row[‘open’]<1200)” and “row[‘open’]<row[‘close’]” with and to generate the conditional expressions “(not(row[‘open’]<1200)) and (row[‘open’]<row[‘close’])”.

As shown in FIG. 6, the analysis portion 191 maps node n34, which indicates the return value, to the generated conditional expression “(not(row[‘open’]<1200)) and (row[‘open’]<row[‘close’])” on a one-to-one basis.

The process in which the analysis portion 191 traces the tree from the node indicating the return value to detect the node indicating the if statement and the branching condition is an example of the process of detecting the portion of the pre-conversion program that includes a conditional branch and calculates a value according to the execution result of the conditional branch.

For example, the analysis portion 191 traces the abstract syntax tree shown in FIG. 5 from node n34 to the parent side and detects the if statement shown at node n23 and the condition shown at n33, which corresponds to the example of detecting the conditional branch “if row[‘open’]<row[‘close’]” in the pre-conversion program shown in FIG. 4. Furthermore, the fact that the analysis portion 191 detects the if statement indicated at node n11 and the condition indicated at n21 is an example of detecting the conditional branch “if row[‘open’]<1200” in the pre-conversion program shown in FIG. 4.

The combination of these conditional branches “if row[‘open’]<row[‘close’]” and “if row[‘open’]<1200” and the return value calculation formula “row[‘close’]−row[‘open’]” indicated at node n34 is an example of the portion of the pre-conversion program that includes a conditional branch and calculates a value according to the execution result of the conditional branch.

The analysis portion 191 detecting the portion of the abstract syntax tree by tracing the abstract syntax tree from node n22 and detecting the portion of the abstract syntax tree by tracing the abstract syntax tree from node n35 are each examples of detecting the portion of the pre-conversion program that includes a conditional branch and calculates a value according to the execution result of the conditional branch.

FIG. 7 is a diagram that shows an example of conversion from a conditional expression to a conditional expression naming statement by the program generation portion 192.

A conditional expression naming statement is represented as an assignment statement that assigns the value of a conditional expression to a logical variable vector. The name of the logical variable vector is also used as the name of the conditional expression.

The logical variable vector here is a vector with logical variables as elements. When executing the conditional expression naming statement included in the post-conversion program, the computer executing the post-conversion program performs the conditional expression calculation for each row of the matrix to be processed, calculates the truth value vector for one column, and assigns it to the logical variable vector. The truth value vector here is a vector whose element values are truth values (i.e., values representing true or false).

A value representing true is also denoted simply as true, and a value representing false is also denoted simply as false. For example, the fact that a logical variable takes a value that represents true is also denoted as a logical variable value being true.

FIG. 7 shows an example of when the program generation portion 192 generates conditional expression naming statements for each of the three conditional expressions shown in FIG. 6. The program generation portion 192 assigns the logical variable vector “cond1”, “cond2”, and “cond3”, whose names are a combination of the string “cond” and a serial number from 1, to the three conditional expressions, and generates a conditional expression naming statement for each conditional expression.

The program generation portion 192 may perform a mechanical conversion from the notation according to the format of the pre-conversion program to the notation according to the format of the post-conversion program when generating the conditional expression naming statement.

In the example in FIG. 7, the program generation portion 192 converts the string “row” in the pre-conversion program to the string “tbl” to generate the conditional expression naming statement.

“row[ ]” in the pre-conversion program represents the elements of the row to be processed and the elements of the column whose column name is indicated in [ ], among the elements contained in the input data in matrix format. On the other hand, “tbl[ ]” in the conditional expression naming statement represents the columns included in the matrix format data “tbl” for which the column name is indicated in [ ].

In the pre-conversion program, the computer executing the program calls a user-defined function for each line of input data to perform processing. In contrast, in the post-conversion program, portions of input data are specified by column, and the computer executing the program performs processing on the specified columns. The processing for a column in this case may be row-by-row processing for that column, or the computer may perform the same processing for all rows in parallel.

Thus, the processing methods assumed in the pre-conversion program and the post-conversion program may differ, and the notation in the pre-conversion program and the notation in the post-conversion program (here, in the conditional expression naming statement) may differ due to the difference in processing methods.

For example, the program generation portion 192 may perform a mechanical conversion from the notation according to the format of the pre-conversion program to the notation according to the format of the post-conversion program based on conversion rules, such as converting a fixed string to a fixed string.

The conditional expression naming statements generated by the program generation portion 192 are not limited to those by logical variable assignment statements as described above. For example, a conditional expression naming statement may be specified as a string conversion rule.

Furthermore, for example, the conditional expression naming statement “cond1=tbl[‘open’]<1200” in FIG. 7 may be specified as a string conversion rule to replace the left-hand side string “cond1” appearing in the post-conversion program with the right-hand side string “tbl[‘open’]<1200”.

Then, before or at the time of execution of the post-conversion program, the string “cond1” appearing in the post-conversion program may be replaced by the string “tbl[‘open’]<1200” representing the conditional expression.

The program generation portion 192 may use the names of conditional expressions specified in other conditional expression naming statements when generating the conditional expression naming statements. For example, in the example in FIG. 7, the program generation portion 192 may generate the conditional expression naming statement “cond2=not cond1 and (tbl[‘open’]<tbl[‘close’])”.

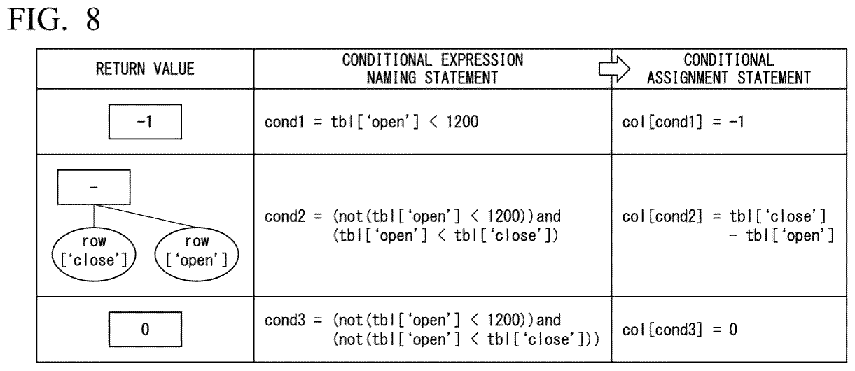

FIG. 8 shows an example of a conditional assignment statement generated by the program generation portion 192. FIG. 8 shows an example of when the program generation portion 192 generates a conditional assignment statement based on the return value shown in FIG. 6 and the conditional expression naming statement shown in FIG. 7.

In the example in FIG. 8, the program generation portion 192 generates a conditional assignment statement by inserting the name of the conditional expression in [ ] of the string “col[ ]=” and inserting the return value calculation formula or, if the return value is a constant, that constant on the right side. For example, the program generation portion 192 inserts the conditional expression name “cond1” in the [ ] of the string “col[ ]=” and the return value “−1” on the right side to generate the conditional assignment statement “col[cond1]=−1”.

The right-hand side of the conditional assignment statement corresponds to the example in the calculation portion.

The conditional assignment statement col[cond_var]=ret_var indicates that the value of each element of one row of the matrix for which the value of cond_var is true is the value indicated by ret_var.

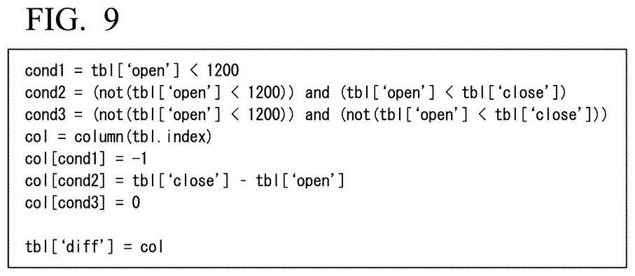

FIG. 9 shows an example of a post-conversion program generated by the program generation portion 192. FIG. 9 shows an example of a post-conversion program obtained by the program generation portion 192 converting the pre-conversion program shown in FIG. 4.

In the example in FIG. 9, “cond1=tbl[‘open’]<1200”, “cond2=(not(tbl[‘open’]<1200)) and (tbl[‘open’]<tbl[‘close’])” and “cond3=(not(tbl[‘open’]<1200)) and (not(tbl[‘open’]<tbl[‘close’]))” are each a description of the conditional expression naming statements shown in FIG. 7.

The computer that executes the post-conversion program shown in FIG. 9 calculates the conditional expressions on the right side of the conditional expression naming statement for each row of data “tbl,” generates a truth value vector for one column of data “tbl,” and assigns it to the logical variable vector on the left side of the conditional expression naming statement.

“col=column(tbl.index)” indicates that an empty column “col” is to be generated for one column of data “tbl”. Here, an empty column for one column of data “tbl” is a column that has the same number of elements as one column of data “tbl” and each element is empty (value unset).

In the execution of “col=column(tbl.index)”, column “col” is generated as one column of data, separate from the data “tbl”. The column “col” can be treated as a vector. Column “col” is also denoted as vector “col”.

The elements of the vector “col” are mapped one-to-one to the rows of the data “tbl”. This is done, for example, by tying the elements of the vector “col” to the same index as the row index of the data “tbl”. The row index here is the identification information that identifies the row. The row index may be provided as a separate data from the elements as a matrix of data “tbl”. Alternatively, if one of the columns of data “tbl” has a fixed (constant) value and the value of each row is different, the value of that column may be used as the row index.

“col[cond1]=−1” indicates that the value “−1” shall be assigned to the element of vector “col” in the row for which the value of the logical variable vector “cond1” is true.

“col[cond2]=tbl[‘close’]−tbl[‘open’]” indicates that the difference obtained by subtracting the element value of the “open” column from the element value of the “close” column of the row is assigned to the element of the row for which the value of the logical variable vector “cond2” is true among the elements of vector “col”.

“col[cond3]=0” indicates that the value “0” shall be assigned to the element of the row for which the value of the logical variable vector “cond3” is true among the elements of the vector “col”.

The setting of the conditional expression in the conditional expression naming statement causes only one of the logical variables “cond1”, “cond2”, and “cond3” used in the conditional assignment statement to be true for each row of data “tbl”. This means that for each row of data “tbl”, only one of the three conditional assignment statements will be used.

This means that, for example, if a computer executing the post-conversion program shown in FIG. 9 executes three conditional assignment statements in parallel processing, the value of the vector “col” is uniquely determined regardless of the order in which the three conditional assignment statements are executed.

“tbl[‘diff’]=col” indicates that the vector “col” is to be added to the data “tbl” as a column with the name “diff”. When the post-conversion program is executed, a new “diff” column is added to the data “tbl” by executing “tbl[‘diff’]=col”.

Comparing the pre-conversion program shown in FIG. 4 and the post-conversion program shown in FIG. 9, the pre-conversion program includes conditional branches using if and return statements, etc., whereas the post-conversion program does not include conditional branches because the selection of return values is indicated by conditional assignment statements. In this respect, the post-conversion program can be said to be more suitable for parallel processing than the pre-conversion program.

In the post-conversion program, only the conditional expression of any one of the multiple conditional assignment statements becomes true, and the value indicated by the calculation portion included in the conditional assignment statement whose conditional expression becomes true is used, ensuring that, during parallel processing, a unique value is obtained regardless of the execution order of the multiple conditional assignment statements. The post-conversion program is also suitable for parallel processing in this respect.

In the post-conversion program, a unique value is obtained regardless of the order in which multiple conditional assignment statements are executed, which not only allows multiple conditional assignment statements to be executed in parallel processing, but also allows the same processing to be performed in the column direction all at once when processing each row of data in matrix format.

For example, when the computer executes “cond1=tbl[‘open’]<1200” in the post-conversion program in FIG. 9, it may read all element values in the “open” column of data “tbl” at once. The computer may then perform a batch comparison of each element value read out with 1200. The computer may then assign the row-by-row truth values resulting from the comparison to the logical variable vector “cond1” in a lump sum.

The computer, when executing “col[cond1]=−1”, may read the truth values from the logical variable vector “cond1” row by row at once. The computer may then assign −1 to the elements of the vector “col” in a batch for rows where the truth value is true.

Thus, if the computer performs the same process in a batch in the column direction, it will execute “col[cond1]=−1”, “col[cond2]=tbl[‘close’]−tbl[‘open’]” and “col[cond3]=0” for all rows in the same order. Such processing is made possible by the fact that unique values can be obtained regardless of the order in which multiple conditional assignment statements are executed.

A computer may batch the same process in parallel processing in the column direction. This reduces program execution time.

Alternatively, in an environment where the program is executed in an interpreted fashion, the portion of the program that is converted to a post-conversion program may be executed as a native function executed in binary code. In this case, the program execution time can also be reduced.

It is also possible that the programmer is familiar with the format of pre-conversion programs that use conditional branching, but is unfamiliar with the format of post-conversion programs that use conditional assignment statements. For example, the pre-conversion program has a high degree of freedom, such as the ability to use user-defined functions, whereas the post-conversion program is library-based and has a relatively low degree of freedom, and the programmer may not be familiar with the library for programming the post-conversion program.

In this case, the programmer can reduce program execution time by creating a pre-conversion program and converting it to a post-conversion program using the program conversion device 100.

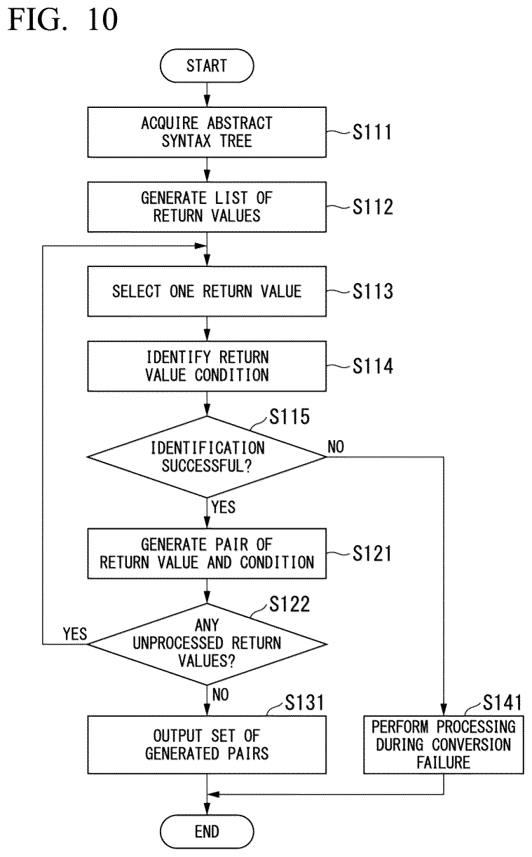

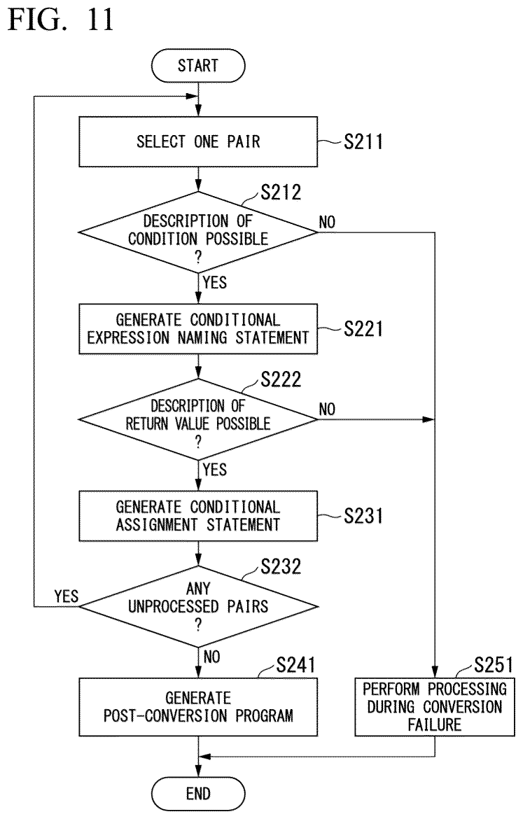

FIG. 10 is a flowchart showing an example of a processing procedure in which the analysis portion 191 generates a set of pairs of return values and conditional expressions. The analysis portion 191 performs the processing shown in FIG. 10 as a pre-processing step before the program generation portion 192 generates the post-conversion program, as illustrated in FIG. 11.

In the process shown in FIG. 10, the analysis portion 191 acquires the abstract syntax tree of the pre-conversion program (Step S111). The analysis portion 191 may generate an abstract syntax tree. Alternatively, if there is an abstract syntax tree that has already been generated, such as if the compiler or interpreter has already generated an abstract syntax tree, the analysis portion 191 may acquire that abstract syntax tree.

Next, the analysis portion 191 searches the abstract syntax tree to generate a list of return values (Step S112). The column of return values in the tabular data in FIG. 6 corresponds to the example of the list of return values generated by the analysis portion 191 exploring the abstract syntax tree in FIG. 5.

Next, the analysis portion 191 selects one return value from the list of return values (Step S113). In the loop from Step S113 to Step S122, the analysis portion 191 generates a pair of each of the return values in the list of return values and a conditional expression indicating the condition under which the return value is employed. In Step S313, the analysis portion 191 selects a return value in the list of return values for which the pair of the return value and conditional expression has not yet been generated.

Next, the analysis portion 191 identifies the conditions under which the return value selected in Step S113 is adopted (Step S114).

For example, the analysis portion 191 traces the abstract syntax tree from the return value node identified in Step S113 to the parent side. Then, the analysis portion 191 obtains the conditional expression of the branch each time a node of the if statement is reached. If the path traced by the analysis portion 191 corresponds to the else of the if statement, the analysis portion 191 takes the negation (NOT) of the conditional expression obtained.

The analysis portion 191 repeats obtaining the conditional expression for the branch and taking the negation of the conditional expression in the case of else until the root of the abstract syntax tree is reached. Upon reaching the abstract syntax tree, the analysis portion 191 combines the acquired conditional expressions (negated in the case of else) with and.

After Step S114, the analysis portion 191 determines whether it succeeded in identifying the condition under which the return value is employed (Step S115).

An example of a case in which the analysis portion 191 fails to identify the condition under which the return value is to be employed is when the conditions of the branch are complex. A further example of a case in which the analysis portion 191 fails to identify the condition under which the return value is to be employed is when an external function is called in the conditional expression of a branch, and the analysis portion 191 does not even analyze the external function. Examples of cases in which the analysis portion 191 does not analyze external functions include cases in which the operating environment of the analysis portion 191 does not allow reference to external function definitions, and cases in which the analysis portion 191 is set not to perform analysis of external functions.

If the analysis portion 191 determines that it failed to identify the condition under which the return value is adopted (Step S115: YES), the program conversion device 100 performs a predetermined process as the processing for program conversion failure (Step S141).

For example, the display portion 120 may display, in accordance with the control of the control portion 190, a message indicating that the conversion of the program was interrupted due to the occurrence of an error, and information indicating the cause of the failed conversion, such as an error code.

Alternatively, if the program conversion device 100 performs program conversion as part of the execution of the pre-conversion program, the pre-conversion program may be executed as is.

After Step S141, the program conversion device 100 terminates the process in FIG. 10.

On the other hand, if it is determined in Step S115 that the condition under which the return value is employed is successfully identified (Step S115: YES), the analysis portion 191 generates a pair of the return value selected in Step S113 and the condition identified in Step S114 (Step S121). One line of tabular data shown in FIG. 6 corresponds to an example of the pair of the return value and conditional expression that the analysis portion 191 generates by analyzing the abstract syntax tree in FIG. 5.

Next, the analysis portion 191 determines whether there are any unprocessed return values (Step S122). Specifically, the analysis portion 191 determines whether there are any return values for which the pair of the return value and conditional expression has not yet been generated.

If the analysis portion 191 determines that there are unprocessed return values, the process returns to Step S113.

On the other hand, if it is determined that there are no unprocessed return values, the analysis portion 191 outputs a set of pairs of return values and conditional expressions generated in Step S121 to the program generation portion 192 (Step S131). The tabular data shown in FIG. 6 corresponds to an example of a set of pairs of return values and conditional expressions.

After Step S131, the program conversion device 100 terminates the process shown in FIG. 10.

FIG. 11 is a flowchart showing an example of the procedure in which the program generation portion 192 generates a post-conversion program.

In the process of FIG. 11, the program generation portion 192 selects one of the set of pairs of return values and conditional expressions generated by the analysis portion 191 (Step S211). The program generation portion 192 generates a conditional assignment statement for each pair of return value and conditional expression in a loop from Step S211 to Step S232. In Step S211, the program generation portion 192 selects, among the set of pairs of return values and conditional expressions generated by the analysis portion 191, a pair for which a conditional assignment statement is yet to be generated.

Next, the program generation portion 192 determines whether the conditions indicated by the conditional expressions in the selected pairs can be described in the format of the updated program (Step S212).

An example of a case in which the conditions indicated by the conditional expressions included in the selected pairs cannot be described in the format of the updated program is when the updated program or a part thereof is composed using a library, and the conditions indicated by the conditional expressions included in the selected pairs cannot be described under constraint conditions on the description of conditional expressions in the library.

If the program generation portion 192 determines that the conditions indicated by the conditional expressions included in the selected pair cannot be described in the format of the updated program (Step S212: NO), the program conversion device 100 performs the processing predetermined as processing for program conversion failure (Step S251).

For example, the display portion 120 may display, in accordance with the control of the control portion 190, a message indicating that the conversion of the program was interrupted due to the occurrence of an error, and information indicating the cause of the failed conversion, such as an error code.

Alternatively, if the program conversion device 100 performs program conversion as part of the execution of the pre-conversion program, the pre-conversion program may be executed as is.

After Step S251, the program conversion device 100 terminates the process shown in FIG. 11.

On the other hand, if it is determined in Step S212 that the conditions indicated by the conditional expressions included in the selected pair can be described in the format of the updated program (Step S212: YES), the program generation portion 192 generates a conditional expression naming statement based on the conditional expressions included in the selected pair (Step S221). As explained with reference to FIG. 7, the program generation portion 192 may generate assignment statements as conditional expression naming statements. Alternatively, the program generation portion 192 may generate string conversion rules as conditional expression naming statements.

Next, the program generation portion 192 determines whether the return values in the selected pairs can be described in the format of the updated program (Step S222).

An example of a case in which the return values in the selected pairs cannot be described in the format of the post-update program is when the post-update program or part thereof is composed using a library and the return values in the selected pairs cannot be described under constraint conditions of the description of the calculation formula in the library.

If the program generation portion 192 determines that the return values in the selected pairs cannot be described in the format of the updated program (Step S212: NO), the process proceeds to Step S251.

After Step S251, the program conversion device 100 terminates the process shown in FIG. 11.

On the other hand, if it is determined in Step S222 that the return values included in the selected pairs can be described in the format of the updated program (Step S212: NO), the program generation portion 192 generates a conditional assignment statement based on the return values included in the selected pairs and the conditional expression naming statement generated in Step S221 (Step S231). As explained with reference to FIG. 8, the program generation portion 192 may generate a conditional assignment statement that assigns a return value to a variable if the condition is satisfied, using the name of the conditional expression contained in the conditional expression naming statement as an indication of the condition.

Next, the program generation portion 192 determines whether there are any unprocessed pairs (Step S232). Specifically, the program generation portion 192 determines whether there are any pairs for which conditional assignment statements have not yet been generated.

If the program generation portion 192 determines that there are unprocessed pairs (Step S232: YES), the process returns to Step S211.

On the other hand, upon determining that there are no unprocessed pairs (Step S232: NO), the program generation portion 192 generates a post-conversion program using the conditional expression naming statement generated in Step S221 and the conditional assignment statement generated in Step S231 (Step S241).

For example, the program generation portion 192 may insert a conditional expression naming statement and a conditional assignment statement into a pre-prepared template, set the name and the like required by the template, such as the name “diff” for the new column shown in FIG. 3, and generate the updated program as shown in FIG. 9.

After Step S241, the program conversion device 100 terminates the process shown in FIG. 11.

As described above, the analysis portion 191 analyzes the pre-conversion program and detects a portion of the pre-conversion program that includes a conditional branch and calculates a value according to the execution result of the conditional branch. The program generation portion 192 generates a post-conversion program in which multiple combinations of conditional expressions and calculation portions that are configured without conditional branches and that indicate values are provided, only one of the multiple conditional expressions becomes true, and the value indicated by the calculation portion combined with the conditional expression that becomes true is used, based on the analysis results.

The post-conversion program generated by the program conversion device 100 can be said to be a program suitable for parallel processing in that it does not include conditional branches in the combination of conditional expressions and calculation portions.

In the post-conversion program generated by the program conversion device 100, only one of the multiple conditional expressions becomes true, and the value indicated by the calculation portion combined with the conditional expression that becomes true is used, ensuring that in parallel processing, a unique value is obtained regardless of the execution order of the multiple combinations. The post-conversion program generated by the program conversion device 100 is also suitable for parallel processing in this respect.

Thus, according to the program conversion device 100, the program can be converted so that program execution can be made more efficient. For example, it is expected that the post-conversion program will be processed in parallel, resulting in a shorter program execution time than for the pre-conversion program.

In addition, it is expected that the reader of the program can easily ascertain the structure of the program in that the post-conversion program is described not in a nested structure of conditional branches, but in a format in which the value is adopted by any of several combinations of conditional expressions and calculation portions.

For example, when the program conversion device 100 converts a pre-conversion program without a library into a post-conversion program with a library, a person who wants to learn how to describe a program with a library can compare the pre-conversion program with the post-conversion program to use it as a reference for describing programs using a library.

The portion of the pre-conversion program that includes a conditional branch and calculates a value according to the execution result of the conditional branch is configured as a user-defined module. The program generation portion 192 replaces an assignment statement that uses the user-defined module to calculate for each first data series, which is one of the row or column of matrix-formatted data, the value of an element in one second data series, which is the different one of the row or column from the first data series, for each first data series, with multiple conditional assignment statements combining a conditional expression and a calculation portion constituted without a conditional branch and indicating a value. In the replaced program (post-conversion program), only the conditional expression of any one of the multiple conditional assignment statements becomes true, and the value indicated by the calculation portion of the conditional assignment statement whose conditional expression becomes true is assigned as the value of an element of one second data series.

Thus, when the pre-conversion and post-conversion programs process data in matrix form, the effect due to increased efficiency of program execution may be increased in that processing is performed for each of multiple rows or multiple columns.

For example, consider the case where row-by-row processing is performed sequentially in both the pre-conversion and post-conversion programs for processing matrix data columns. In this case, it is expected that the reduction in program execution time in the post-conversion program relative to the pre-conversion program for one row of data will be multiplied by the number of rows for the entire data in matrix form.

If the post-conversion program is written using a library that performs matrix processing in parallel, or if the post-conversion program also performs row-by-row processing in parallel, the execution time of the post-conversion program is further reduced.

When the program conversion device 100 converts the part of the pre-conversion program that is executed by calling a user-defined module into a part that is embedded in the program body of the post-conversion program, the post-conversion program is expected to further reduce program execution time to the extent that module calls are no longer required.

The program generation portion 192 replaces the portion of a pre-conversion program executed in an interpreted manner that includes a conditional branch and calculates a value according to the execution result of the conditional branch into a portion which is provided with a plurality of combinations of a conditional expression and a calculation portion presenting a value and configured without including a conditional branch, and which uses a value indicated by the calculation portion combined with the conditional expression that becomes true, where only one conditional expression from among the plurality of conditional expressions becomes true.

As mentioned above, the post-conversion program is suitable for parallel processing. In this regard, it is conceivable that the computer executing the post-conversion program or a portion of the post-conversion program may use an accelerator to execute the post-conversion program or a portion of the post-conversion program. In an environment where programs are executed in an interpreted manner, the effect of faster processing using accelerators is expected to be particularly noticeable.

The analysis portion 191 also analyzes the pre-conversion program using an abstract syntax tree.

If an abstract syntax tree of the pre-conversion program has already been generated for purposes other than program conversion, such as for compilation or interpreter execution, the analysis portion 191 can use this abstract syntax tree and does not need to separately generate an abstract syntax tree for program conversion.

According to the program conversion device 100, the processing load is expected to be light and the processing time is expected to be reduced in this respect.

Alternatively, when the analysis portion 191 generates an abstract syntax tree for program conversion, if an abstract syntax tree generation algorithm is provided for purposes other than program conversion, such as for compilation or interpreter execution, the analysis portion 191 can generate an abstract syntax tree using that algorithm. In this case, according to the program conversion device 100, the storage capacity of the program conversion device 100 is relatively small in that there is no need to prepare a separate abstract syntax tree generation algorithm for program conversion.

FIG. 12 is a diagram showing an example of the configuration of a program conversion device.

In the configuration shown in FIG. 12, the program conversion device 610 is provided with an analysis portion 611 and a program generation portion 612.

In such a configuration, the analysis portion 611 analyzes the program and detects a portion that includes a conditional branch and calculates a value according to the execution result of the conditional branch. The program generation portion 612 generates a program in which multiple combinations of conditional expressions and calculation portions that are configured without conditional branches and that indicate values are provided, only one of the multiple conditional expressions becomes true, and the value indicated by the calculation portion combined with the conditional expression that becomes true is used, based on the analysis results.

The analysis portion 611 is an example of an analysis means. The program generation portion 612 is an example of a program generation means.

The program generated by the program conversion device 610 can be said to be a program suitable for parallel processing in that it does not include conditional branches in the combination of conditional expressions and calculation portions.

In the program generated by the program conversion device 610, only one of the multiple conditional expressions becomes true, and the value indicated by the calculation portion combined with the conditional expression that becomes true is used, ensuring that in parallel processing, a unique value is obtained regardless of the execution order of the multiple combinations. The program generated by the program conversion device 610 is also suitable for parallel processing in this respect.

Thus, according to the program conversion device 610, the program can be converted so that program execution can be made more efficient. For example, it is expected that the program generated by the program conversion device 610 will be processed in parallel, resulting in a shorter program execution time than for the pre-conversion program.

In addition, it is expected that the reader of the program can easily ascertain the structure of the program in that the program generated by the program conversion device 610 is described not in a nested structure of conditional branches, but in a format in which the value is adopted by any of several combinations of conditional expressions and calculation portions.

For example, when the program conversion device 610 converts a program without a library into a program with a library, a person who wants to learn how to describe a program with a library can compare the program prior to conversion by the program conversion device 610 with the program after conversion to use it as a reference for describing programs using a library.

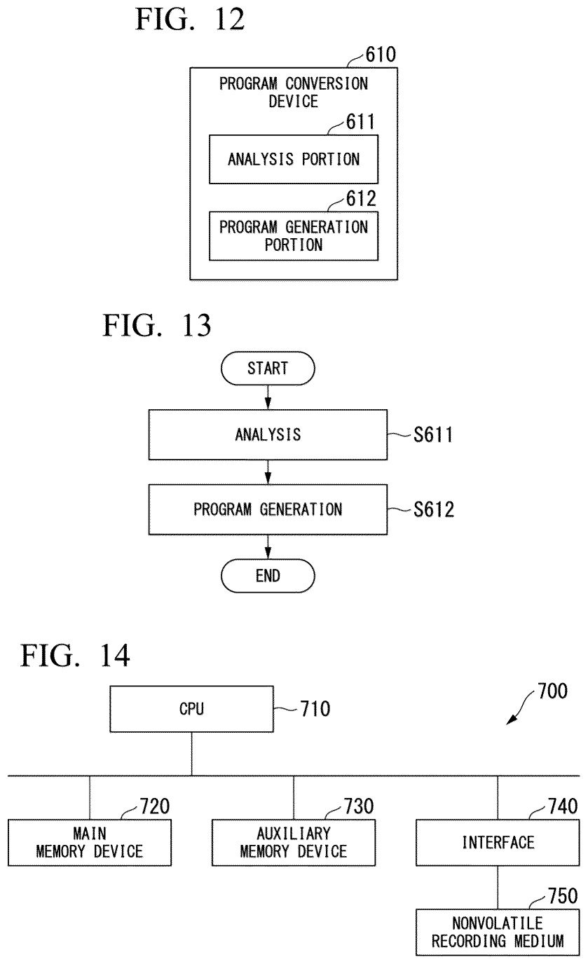

FIG. 13 is a diagram showing an example of the processing procedure in the program conversion method.

The process shown in FIG. 13 includes performing an analysis (Step S611) and generating the program (Step S612).

In performing an analysis (Step S611), the computer analyzes the program and detects a portion that includes a conditional branch and calculates a value according to the execution result of the conditional branch.

In generating the program (Step S612), a computer generates a program in which multiple combinations of conditional expressions and calculation portions that are configured without conditional branches and that indicate values are provided, only one of the multiple conditional expressions becomes true, and the value indicated by the calculation portion combined with the conditional expression that becomes true is used, based on the analysis results.

The program obtained by the program conversion method shown in FIG. 13 can be said to be a program suitable for parallel processing in that it does not include conditional branches in the combination of conditional expressions and calculation portions.

In the program obtained by the program conversion method shown in FIG. 13, only one of the multiple conditional expressions becomes true, and the value indicated by the calculation portion combined with the conditional expression that becomes true is used, ensuring that in parallel processing, a unique value is obtained regardless of the execution order of the multiple combinations. The program obtained by the program conversion method shown in FIG. 13 can be said to be a program also suitable for parallel processing in this respect.

Thus, according to the program conversion method shown in FIG. 13, the program can be converted so that program execution can be made more efficient. For example, it is expected that the program obtained by the program conversion method shown in FIG. 13 will be processed in parallel, resulting in a shorter program execution time than for the pre-conversion program.

In addition, it is expected that the reader of the program can easily ascertain the structure of the program in that the program obtained by the program conversion method shown in FIG. 13 is described not in a nested structure of conditional branches, but in a format in which the value is adopted by any of several combinations of conditional expressions and calculation portions.

For example, when a program without a library is converted into a program with a library by the program conversion method shown in FIG. 13, a person who wants to learn how to describe a program with a library can compare the program prior to conversion by the program conversion method shown in FIG. 13 with the program after conversion to use it as a reference for describing programs using a library.

FIG. 14 is a schematic block diagram showing the configuration of a computer according to at least one example embodiment.

In the configuration shown in FIG. 14, a computer 700 is provided with a CPU 710, a main memory device 720, an auxiliary memory device 730, an interface 740, and a nonvolatile recording medium 750.

Either one or more of the above program conversion device 100 and program conversion device 610, or any part thereof, may be implemented in the computer 700. In that case, the operations of each of the above-mentioned processing portions are stored in the auxiliary memory device 730 in the form of a program. The CPU 710 reads the program from the auxiliary memory device 730, deploys it in the main memory device 720, and executes the above processing according to the program. The CPU 710 also reserves a storage area in the main memory device 720 according to the program. Communication between each device and other devices is performed by the interface 740, which has a communication function and performs communication according to the control of the CPU 710. The interface 740 also has a port for the nonvolatile recording medium 750 and reads information from and writes information to the nonvolatile recording medium 750.

When the program conversion device 100 is implemented in the computer 700, the operations of the control portion 190 and the various parts thereof are stored in the auxiliary storage device 730 in the form of a program. The CPU 710 reads the program from the auxiliary memory device 730, deploys it in the main memory device 720, and executes the above processing according to the program.

The CPU 710 also allocates the storage area corresponding to the memory portion 180 in the main memory device 720 according to the program.

Communication with other devices by the communication portion 110 is performed by the interface 740, which has communication functions and operates according to the control of the CPU 710.

The display by the display portion 120 is performed by the interface 740 having a display device and displaying various images according to the control of the CPU 710.

Acceptance of user operations by the operation input portion 130 is performed by the interface 740 having input devices such as a keyboard and mouse, for example, to accept user operations and output information indicating accepted user operations to the CPU 710.

When the program conversion device 610 is implemented in the computer 700, the operations of the analysis portion 611 and the program generation portion 612 are stored in the auxiliary memory device 730 in the form of programs. The CPU 710 reads the program from the auxiliary memory device 730, deploys it in the main memory device 720, and executes the above processing according to the program.

The CPU 710 also reserves a storage area in the main memory device 720 for the program conversion device 610 to perform processing according to the program.

Communication between the program conversion device 610 and other devices is performed by the interface 740, which has communication functions and operates according to the control of the CPU 710.

Interaction between the program conversion device 610 and the user is performed by the interface 740, which has a display device and input device and operates according to the control of the CPU 710.

Any one or more of the above programs may be recorded on the nonvolatile recording medium 750. In this case, the interface 740 may read the program from the nonvolatile recording medium 750. The CPU 710 may then directly execute the program read by the interface 740, or it may be stored once in the main memory device 720 or the auxiliary memory device 730 and then executed.

A program for executing all or part of the processing performed by the program conversion device 100 and the program conversion device 610 may be recorded on a computer-readable recording medium, and the computer system may read the program recorded on this recording medium and execute it to perform the processing of each part. The term “computer system” here shall include an operation system and hardware such as peripherals.

In addition, “computer-readable recording medium” means a portable medium such as a flexible disk, magneto-optical disk, ROM (Read Only Memory), CD-ROM (Compact Disc Read Only Memory), or other storage device such as a hard disk built into a computer system. The above program may be used to realize some of the aforementioned functions, and may also be used to realize the aforementioned functions in combination with programs already recorded in the computer system.

While the above example embodiments of this invention have been described in detail with reference to the drawings, it should be understood that specific configurations are not limited to these example embodiments, with designs and the like also included to the extent that they do not depart from the gist of this invention.

### INDUSTRIAL APPLICABILITY

The present invention may be applied to a program conversion device, a program conversion method, and a recording medium.

### DESCRIPTION OF REFERENCE SIGNS

100, 610 Program conversion device
110 Communication portion
120 Display portion
130 Operation input portion
180 Memory portion
190 Control portion
191, 611 Analysis portion
192, 612 Program generation portion

What is claimed is:

1. A program conversion device comprising:
at least one memory configured to store instructions; and
at least one processor configured to execute the instructions to:
analyze a first program;
detect a portion of the first program that includes a conditional branch and calculates a value according to an execution result of the conditional branch; and
on the basis of the analysis result, generate a second program including a plurality of combinations of a conditional expression and a calculation expression and using a value indicated by the calculation expression combined with the conditional expression that becomes true, wherein the calculation expression indicates the value and does not include a conditional branch and only one conditional expression from among the plurality of conditional expressions becomes true.

2. The program conversion device according to claim 1, wherein the portion of the first program that includes the conditional branch and calculates a value according to an execution result of the conditional branch is configured as a user-defined module,
the at least one processor is configured to execute the instructions to replace an assignment statement that uses the user-defined module to calculate the value of an element for each first data series with multiple conditional assignment statements combining the conditional expression and the calculation expression including without a conditional branch and indicating a value, wherein the first data series is one of row and column of matrix-formatted data and second data series is other of the row or the column of the matrix-formatted data, and
in the replaced second program, only the conditional expression of any one of the multiple conditional assignment statements becomes true, and the value indicated by the calculation expression of the conditional assignment statement whose conditional expression becomes true is assigned as the value of an element of the one second data series.

3. The program conversion device according to claim 1, wherein the at least one processor is configured to execute the instructions to replace the portion of the first program executed in an interpreted manner that includes the conditional branch and calculates a value according to an execution result of the conditional branch into an expression which is provided with a plurality of combinations of a conditional expression and a calculation expression indicating a value and configured without including a conditional branch, and which uses a value indicated by the calculation expression combined with the conditional expression that becomes true, where only one conditional expression from among the plurality of conditional expressions becomes true.

4. The program conversion device according to claim 1, wherein the at least one processor is configured to execute the instructions to analyze the program using an abstract syntax tree.

5. A program conversion method executed by a computer, the method comprising:
analyzing a first program;
detecting a portion of the first program that includes a conditional branch and calculates a value according to an execution result of the conditional branch; and
generating, on the basis of the analysis result, a second program including a plurality of combinations of a conditional expression and a calculation expression and using a value indicated by the calculation expression combined with the conditional expression that becomes true, wherein the calculation expression indicates the value and does not include a conditional branch and only one conditional expression from among the plurality of conditional expressions becomes true.

6. A non-transitory recording medium that records a program for causing a computer to execute:
analyzing a first program;
detecting a portion of the first program that includes a conditional branch and calculates a value according to an execution result of the conditional branch; and
generating, on the basis of the analysis result, a second program including a plurality of combinations of a conditional expression and a calculation expression and using a value indicated by the calculation expression combined with the conditional expression that becomes true, wherein the calculation expression indicates the value and does not include a conditional branch and only one conditional expression from among the plurality of conditional expressions becomes true.
